(19) United States
(12) Patent Application Publication
(10) Pub. No.: US 2007/0121685 A1
(43) Pub. Date: May 31, 2007

(54) Laser device

(75) Inventor: Keisuke Maekawa, Yokohama-shi (JP)

Correspondence Address: BIRCH STEWART KOLASCH & BIRCH, PO BOX 747, FALLS CHURCH, VA, 22040-0747, US

(73) Assignee: NICHIA CORPORATION

(21) Appl. No.: 11/604,213

(22) Filed: Nov. 27, 2006

(30) Foreign Application Priority Data
Nov. 28, 2005 (JP) 2005-342566
Jul. 14, 2006 (JP) 2006-194600

(51) Int. Cl. H01S 3/10

(52) U.S. Cl. 372/21

(57) ABSTRACT

A laser device emits a higher harmonic wave of multi-longitudinal mode laser light and is capable of realizing higher efficiency and higher performance in a simple and economical fashion. The laser device includes a light source formed from a semiconductor laser emitting a fundamental wave in multi-longitudinal mode, and a wavelength converting element formed from a polarization inversion element provided with two or more of polarization inversion regions, and each region has a period Δ that corresponds to the longitudinal mode constructing the fundamental wave, and the higher harmonic wave obtained by the polarization inversion element is in multi-longitudinal mode.

This application claims priority under 35 U.S.C. §119 of Japanese Application Nos. 2005-342566 and 2006-194600, filed on Nov. 28, 2005 and Jul. 14, 2006 respectively, the entire contents of which are hereby incorporated by reference.

### BACKGROUND OF THE INVENTION

1. Field of the Invention

The invention relates a laser device using a multi-periodic polarization inversion element.

2. Description of Related Art

Laser light generated by semiconductor or solid-state lasers is limited to a specific wavelength that depends on the construction material of the laser source. However, the wide field of applications for lasers creates a demand for laser light of various wavelengths according to the specific use. Therefore, expanding the wavelength region of an existing laser source can rapidly extend laser applications. Also, this wavelength versatility should not be attained without trading off other desirable or required characteristics, such as smaller size, lighter weight, higher output, less waste heat, and reduced power consumption.

Examples of the related art laser technology include red light GaAs-based semiconductor lasers and blue light GaN-based semiconductor lasers. However, green light has not yet been realized in compound semiconductor lasers in terms of characteristics and reliability that compares to red and blue laser lights. However, the production of the next generation of displays for projectors, televisions and the like becomes possible by realizing green laser light along with red and blue laser lights.

As a result, research has been conducted to obtain green laser light. For example, Japanese Laid-open Patent Application Publication No. H11(1999)-2849 describes a combined utilization, under strict conditions, of a semiconductor laser as an excitation light source, a Nd-doped solid-state laser crystal as a laser rod, and a nonlinear crystal to convert laser light to a higher harmonic wave. This type of combination, as shown in FIG. 8, uses a semiconductor laser 70 that outputs a narrow wavelength range. In FIG. 8, light 71 from the semiconductor laser 70 is condensed by a lens 72 and is guided to a solid-state laser crystal 73 that efficiently excites a narrow absorption band to obtain infrared radiation 74. Then, the infrared radiation passes through a nonlinear crystal 75 to obtain green light as a second harmonic wave 76.

Japanese Laid-open Patent Application Publication No. H6(1994)-69582 describes a shorter wavelength light source in which a fundamental wave emitted from a semiconductor laser is introduced into a polarization inversion-type wavelength converting element to convert the fundamental wave into a higher harmonic wave, while an unconverted part of the fundamental wave emitted from the polarization inversion-type wavelength converting element is optically fed back to the active layer of the semiconductor laser by a diffraction grating. Here, light having a higher harmonic wave is extracted as reflected light from the diffraction grating or diverged light from a dichroic mirror. In this shorter wavelength light source, the wavelength of the semiconductor laser can be varied by changing the angle of the diffraction grating. In addition, the polarization inversion-type wavelength converting element is provided with a polarization inversion structure that has no fixed periodicity, such as a divided structure having multiple periods and a chirped structure, so that the wavelength of a higher harmonic wave emitted from the polarization inversion-type wavelength converting element can be varied with respect to the varying wavelength of the semiconductor laser.

These conventional devices, such as the wavelength converting device described in Japanese Laid-open Patent Application Publication No.H11(1999)-2849, are aimed at obtaining a higher harmonic wave corresponding to one period by using a wavelength converting element having a constant polarization inversion period, to emit laser light in a single-longitudinal mode. However, the single-longitudinal mode laser light tends to cause interference, resulting in a speckled pattern. Thus, for applications in various displays and projectors, multi-longitudinal-mode laser light is more suitable than single-longitudinal-mode laser light. Green light especially has a higher luminosity factor than that of red light or blue light, and consequently, multi-longitudinal-mode laser light has high demand in order to control dazzle.

In the shorter wavelength light source described in Japanese Laid-open Patent Application Publication No. H6(1994)-69582, a wavelength converting element with a structure having irregular polarization inversion periods such as a divided structure or a chirped structure is used in order to correspond to the wavelength changes in the fundamental wave. Each of the periods is set with respect to respective wavelengths of the changing wavelength of the fundamental wave. For example, a period of 3.6 μm is set for a fundamental wave of 850 nm and a period of 3.8 μm is set for a fundamental wave of 860 nm. That is, the obtained laser light to has a higher harmonic wave corresponding to one polarization inversion period in a way similar to the wavelength converting device described in Japanese Laid-open Patent Application Publication No. H11(1999)-2849. The higher harmonic wave obtained by wavelength conversion is selectively extracted through a diffraction grating and a dichroic mirror, so that the obtained laser light is in single longitudinal mode.

In addition, in the related art devices, high quality is required for each such member in order to combine a semiconductor laser, a solid-state laser crystal, and a non-linear crystal. Consequently, there have been problems of increases in the cost of production and difficulties in securing a physically stable and functional combination between the materials.

### SUMMARY OF THE INVENTION

An object of the invention, in part, is to solve the disadvantages of laser technology of the related art. One object of the invention is to provide a laser device that emits a higher harmonic wave of multi-longitudinal mode laser light, and realizes a high efficiency and a high performance laser device by combining basic components capable of realizing higher efficiency and higher performance in a simple and cost-effective manner.

The invention, in part, pertains to a laser device and a method of manufacturing a laser device that includes a light source which is a semiconductor laser emitting a fundamental wave in a multi-longitudinal mode, and a wavelength converting element which is a polarization inversion element having at least two polarization inversion periodic regions, each region having a period A corresponding to a longitudinal mode constructing the fundamental wave, and a higher harmonic wave generated by the polarization inversion element is in a multi-longitudinal mode.

It is to be understood that both the foregoing general description and the following detailed description are exemplary and explanatory and are intended to provide further explanation of the invention as claimed.

### BRIEF DESCRIPTION OF THE DRAWINGS

The accompanying drawings are included to provide a further understanding of the invention. The drawings illustrate embodiments of the invention and together with the description serve to explain the principles of the embodiments of the invention.

FIG. 1 schematically shows periods in a polarization inversion element used in a laser device of the invention.

FIGS. 2(a)-2(d) show schematic diagrams of spectra of laser light showing wavelength conversion of laser light in a laser device of the invention.

FIG. 3 schematically shows periods in a polarization inversion element used in a laser device of the invention.

FIG. 4 schematically shows other periods in a polarization inversion element used in a laser device of the invention.

FIG. 5 shows a schematic view of a laser device of the invention.

FIG. 6 schematically shows periods in a polarization inversion element used in a laser device of the invention.

FIG. 7 is a diagram of spectra of laser light showing wavelength conversion of laser light in another laser device of the invention.

FIG. 8 shows a schematic view of a related art green laser device.

### DETAILED DESCRIPTION OF THE PREFERRED EMBODIMENTS

Advantages of the present invention will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

The laser device according to the invention mainly uses a semiconductor laser device as the light source and a polarization inversion element as the wavelength converting element.

Any known semiconductor laser device can be used as the semiconductor laser device. Especially, in order to obtain a second harmonic wave of green laser light, a semiconductor laser device capable of realizing an oscillation wavelength of from about 1000 nm to 1200 nm is suitable. Also, a semiconductor device capable of emitting a fundamental wave in multi-longitudinal mode, i.e., a Fabry-Perot laser, is preferred. Generally, an interval in multi-longitudinal mode can be expressed as λ²/(2·Neq·L), where λ represents the emission wavelength, Neq represents the effective refractive index, and L represents the resonator length. By converting approximately all modes in the multi-longitudinal mode to their respective wavelengths, green laser light in multi-longitudinal mode can be extracted efficiently.

In the invention, the semiconductor laser preferably emits a fundamental wave in a multi-longitudinal mode having a main emission wavelength between about 1000 nm and 1200 nm.

One typical example of such a semiconductor laser device uses a substrate made of InP. InP has proved reliable in the field of optical-communications. The example also includes an active layer represented by a formula InₓGa_{1-x-y}N_{z}As_{y}P_{1-y}, with the approximate proportions of 0.1<x<0.84, 0.25<y<0.5, and z=0 or 1. Such a substrate and semiconductor layer is described in, for example, Japanese Laid-open Patent Application Publication Nos. 2005-101483, 2002-359249, 2001-345328, 2000-156364, H11(1999)-204855, and H11(1999)-238686.

Various types of structures such as a ridge waveguide type or a buried heterostructure (BH) type can be used for the semiconductor laser device, but a BH type laser device is preferable in order to minimize power-loss and to achieve greater power density.

The polarization inversion element functions as a wavelength conversion device or a light modulation device for laser light emitted from the semiconductor laser device, and is mainly capable of converting the laser light to a second harmonic wave. For such a polarization inversion element, any known polarization inversion element can be used (for example, see Japanese Laid-open Patent Application Publication Nos. 2005-258348, 2005-234147, 2005-070192, and 2003-207811).

The polarization inversion element can be made of, for example, single crystal of lithium niobate (LiNbO₃, LN), lithium tantalate (LiTaO₃, LT), lithium niobate-lithium tantalate solid solution or lithium potassium niobate (K₃Li₂Nb₅O₁₅), potassium niobate (KNbO₃, KN), or potassium titanyl phosphate (KTiOPO₄, KTP). However, any suitable material can be used. In view of the polarization inversion property, single crystal lithium niobate and single crystal lithium niobate-lithium tantalate solid solution are preferable. In addition, in order to improve the resistance against optical damage of the three-dimensional optical waveguide, at least one metallic element selected from magnesium (Mg), zinc (Zn), scandium (Sc), or indium (In) may be contained therein. Among them, magnesium is preferable. Further, at least one rare earth element (such as Nd, Er, Tm, Ho, Dy, and Pr) may be contained in the single crystal as a dopant. The rare earth element functions as an additional element for laser oscillation.

The method for inverting the polarization of the substrate formed by using the single crystal of the invention is not specifically limited, and various methods such as a proton exchange method, a diffusion method, an electric field applying method, and a micro-domain inverting method using electron beam technology can be used (For example, see Japanese Laid-open Patent Application Publication Nos. H5(1993)-249522 and 2005-208197). The substrate made of such a single crystal material may be formed with an off-cut angle of about 1° to 20°. The substrate may be used as a so-called X-cut substrate, Y-cut substrate, or Z-cut substrate.

The polarization inversion element of the invention includes at least two polarization inversion periodic regions, and each region has a period Δ corresponding to a longitudinal mode constructing the fundamental wave.

Although it depends on the mode of the semiconductor laser, each periodic region of the polarization inversion element suitably has about two or more periodic regions, about 2 to 20 periodic regions, about 2 to 15 periodic regions, about 2 to 10 periodic regions, or about 2 to 6 periodic regions, and more preferably, it has about 4 to 10 periodic regions. Moreover, when multiples of periodic regions having different periods Δ from each other are used, double waves can be formed that correspond to all modes in the multi-longitudinal mode of the semiconductor laser device at arbitrary gain widths, so that a second harmonic wave in multi-longitudinal mode can be obtained. That is, “having two or more polarization inversion periodic regions” means either “having two or more regions where polarization inversion structures with a constant period Δ are formed” or “having two or more regions where polarization inversion structures with a mean period Δ are formed”. Further, a configuration having two or more regions where polarization inversion structures within a range of Δ±δ may be formed.

In each periodic region, a suitable range for the period Δ is selected in order to adjust the convertible wavelength and the wavelength of the higher harmonic wave converted from the fundamental wave, with respect to the wavelength of the fundamental wave of the laser device and the positions and numbers of the modes. For example, it is preferable to select an arbitrary period A within a range between about 2.5 and about 8 μm. Especially, when the arbitrary period A within a range between about 3.1 and about 3.5 μm is selected, green laser light can be effectively obtained. In the laser device, it is also preferable that the polarization inversion element has respective differences between the periods a of the periodic regions being set to from about 0.01 to about 0.08 μm, set to constant or has a range of period Δ within a range between about 3.1 and about 3.5 μm.

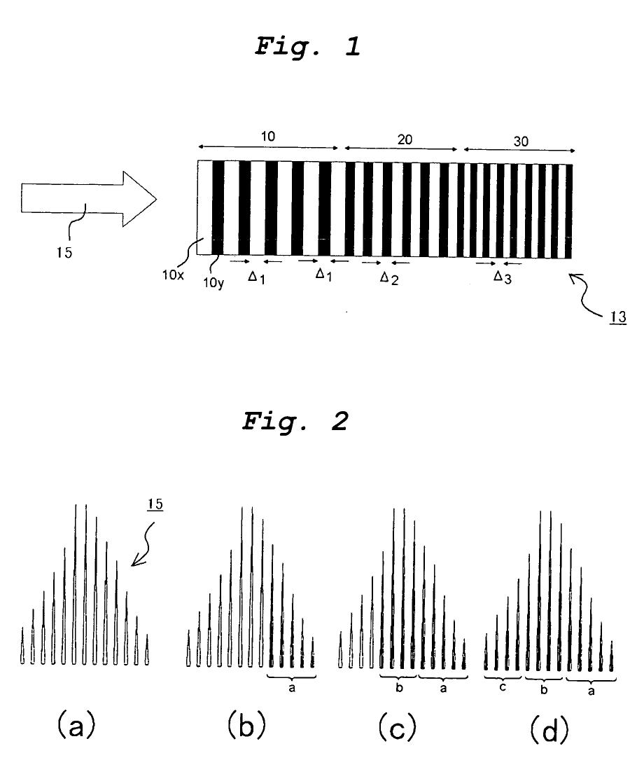

For example, in FIG.1 shows a polarization inversion element 13 that has three periodic regions 10, 20, 30 as first to third periodic regions, respectively. In each periodic region, the period Δ has a paired structure made of regions 10x and 10y that have different polarization directions. Here, 10x is a spontaneously polarized region and 10y is a reversed polarization region. In addition, the periods Δ₁, Δ₂, and Δ₃ in the respective periodic regions 10, 20, 30 differ each other. For example, in this arrangement, light 15 in a predetermined wavelength region near 1100 nm is converted in the first periodic region 10, light in the other predetermined wavelength region near 1100 nm is converted in the second periodic region 20, and light in another predetermined wavelength region near 1100 nm is converted in the third periodic region 30. As a result, the wavelength of the emitting light is converted and a second harmonic wave in multi-longitudinal mode can be obtained.

The period Δ is preferably equal to the coherence length that is a distance from each generating point to the point where the intensity of the composite second harmonic wave takes a downward turn. That is, it is preferable that the direction of polarization inverts at every coherence length. With this arrangement, intensity of the obtained second harmonic wave can increase. The coherence length L is generally represented by the formula L=λ_{f}/4·(n_{SH}−n_{F}). Consequently, when the coherence length is equal to the period Δ, the period Δ can be represented by the formula Δ=λ_{f}/4·(n_{SH}−n_{F}). Here, λ_{f} is the wavelength of the incident fundamental wave in vacuum, n_{SH} is the refractive index of the fundamental wave, and n_{F} is the refractive index of the second harmonic wave.

When the periods Δ are constant or at a uniform value in a periodic region, the fundamental wave that can be converted within the periodic region that corresponds to a longitudinal mode. In other words, when the polarization inversion ratio (polarization inversion domain width/polarization inversion period) in the polarization inversion element is adjusted to about the 50% at which the above-described ideal polarization inversion period structure can be shown, the period Δ in a periodic region can be adjusted to a uniform value. In such cases, it is preferable that the number of periodic regions is designed according to the number of multi-longitudinal modes of the semiconductor laser.

Also, double waves can be generated effectively in each periodic region by frequency-chirping the periods in a range between Δ−δ and Δ+δ, and the energy converting efficiency can further be improved. For example, the periods of Δ−δ through Δ+δ in a periodic region can be adjusted to match the suitable number of a plurality of longitudinal modes of the fundamental wave emitted from the semiconductor laser.

In addition, when the polarization inversion element has three of the first to third periodic regions having different periods of Δ₁±α, Δ₂±β, Δ₃±γ (where α, β, and γ may either be the same or different) respectively, each wavelength region of laser light 15 in multi-longitudinal mode (see FIG. 2(a)) emitted from the semiconductor laser is converted as described below. A part a of light 15 in the wavelength region near 1100 nm is converted in the first periodic region (see FIG. 2(b)), a different part of light b in the wavelength region near 1100 nm is converted in the second periodic region (see FIG. 2(c)), and a further different part of light c in the wavelength region near 1100 nm is converted in the third periodic region (see FIG. 2(d)). As a result, light emitted from the semiconductor laser converts at every wavelength so that a second harmonic wave in multi-longitudinal mode can be obtained.

In the invention, the polarization inversion ratio of the polarization inversion element may be adjusted within a range of about 50±7%, within a range of about 50±5%, within a range of about 50±3%, within a range of about 50±2%, within a range of about 50±1%, or within a range of about 50±0.5%. With this arrangement, the polarization inversion element can be adjusted to multiple longitudinal modes of the fundamental wave according to the fluctuation or deviation of the polarization inversion ratio. As a result, the wavelength of the laser light can be efficiently converted and a desired higher harmonic wave can be obtained. That is, when a certain range is allowed in the polarization inversion ratio, multiple periods Δ are formed in a periodic region, so that the range of wavelength that can be converted in the periodic region can be extended.

In another respect of the invention, it is preferable to adjust the range of convertible wavelength in the polarization inversion element in order to reduce/absorb the fluctuation in the wavelength of the semiconductor laser. For example, the main wavelength of the semiconductor laser and the gain-bandwidth thereof (full width at half maximum—FWHM) is adjusted to about the main wavelength of the laser ±gain-bandwidth, to about the main wavelength of the laser ±gain-bandwidth·(⅘), to about the main wavelength of the laser ±gain-bandwidth·(⅗), to about the main wavelength of the laser ±gain-bandwidth/2, or to about the main wavelength of the laser ±5 nm. With this arrangement, individual differences between the semiconductor lasers and wavelength dispersion during operation can be sufficiently reduced. Therefore, regardless of such differences, a desired second harmonic wave in the multi-longitudinal mode can be obtained. Moreover, this technology also can reduce fluctuations in the wavelength that can be converted in the polarization inversion element due to the deviation in the polarization inversion ratio.

In situations where the periods Δ fluctuate due to deviations in the polarization inversion ratio among the periodic regions and the periods Δ partially overlap with other periods of other periodic regions, i.e., in situations where a common period Δ is provided partially in a periodic region and another periodic region, a range of wavelengths that can be converted in a periodic region can partially overlap with another range of wavelengths that can be converted in another periodic region.

The width of overlapping will affect the intensity distribution of the obtained higher harmonic wave. For example, the intensity of the obtained higher harmonic wave is enhanced in the part of wavelength region that overlaps (a wavelength that can be converted in two or more periodic regions), and the intensity of the obtained harmonic wave is reduced in the part of the wavelength region that does not overlap (a wavelength that can be converted in only one periodic region). In other words, if the difference between the period Δx (or the mean period Δx′) in the periodic region and the period Δy (or the mean period Δy′) in both the periodic region and another periodic region is reduced, the range of overlapping in the wavelength that is convertible in adjacent periodic regions will increase, and the wavelength range convertible in two or more periodic regions will increase. If the difference between the periods Δ increases, then the overlapping range of the wavelength that is convertible in the adjacent periodic regions will decrease, and the wavelength range convertible in only one periodic region will increase. If the difference between the periods Δ is further increased, then the range in which the wavelengths convertible in the adjacent periodic regions disappears, so that a wavelength range that is impossible to convert in any periodic regions will exist. Therefore, by adjusting the difference between the periods Δ, one can adjust the width of overlapping in the wavelength range that can be converted in the adjacent periodic regions.

In each periodic region, the number of periods Δ can be set differently than other periodic regions. In addition, the length of each periodic region is not necessarily the same, however, it is preferable that the length of each periodic region is the same. Generally, a length of the periodic region (for example, a length in lateral direction shown in FIG. 1) affects the intensity of the obtained higher harmonic wave. That is, lengthening the periodic region increases the intensity of the obtained higher harmonic wave. Therefore, it is preferable that the length of each periodic region correspond to the desired strength of the higher harmonic wave. Also, multiple periodic regions may be placed from the semiconductor laser side in order with the sizes of the periods Δ or the mean period Δ in descending order or ascending order, or randomly.

A preferable range of the difference in period Δ between each periodic region, for example, the size of (Δ1−Δ2) or (Δ2−Δ3) shown in FIG. 1, i.e., the difference in period Δ between the periodic regions having the closest periods Δ, or the difference in the mean periods Δ between the periodic regions having the closest mean periods Δ, can be selected according to the wavelength and the like of the semiconductor laser. It is preferable to set the difference in a range of, for example, from about 0.01 to about 0.08 μm, from about 0.02 to about 0.05 μm, or from about 0.02 to 0.03 μm. This arrangement is especialy preferred in order to efficiently obtain a higher harmonic wave of green laser light.

The differences in the periods Δ or the mean periods Δ in the respective periodic regions are prefereably kept constant. With this arrangement, a wavelength that can be converted in each periodic region can be placed at a regular interval. In addition, when all of (n−1) pieces of the differences among the mean period Δ present among the n pieces of the periodic regions are made with a constant value, the (n−1) pieces of overlapping can be placed at substantially constant intervals. With this arrangement, as exemplified in FIG. 2, the wavelengths a to c, can be placed at a constant interval to be converted in respective periodic regions, so that a higher harmonic wave whose intensity distribution similar to that of the fundamental wave can be obtained. If the difference of the mean periods Δ are set randomly, the overlapping parts of the wavelengths that can be converted in adjacent periodic regions are placed at random intervals, so that the intensity distribution of the obtained higher harmonic wave will be different from that of the fundamental wave. Therefore, it is preferable to design the degree (in other words, a width) of the overlapping in view of the intensity distribution of the higher harmonic wave that is desired.

Generally, the intensity of the light obtained using the polarization inversion element enhances by increasing the length of the single crystal (the length of the element) through which the laser light passes. At the same time, when the length of the single crystal is increased, light will scatter at the interface between the spontaneously polarized region and the polarization inversion region in the single crystal. Therefore, it is preferable to design the length of the element in view of the absorption and wavelength conversion efficiency of the laser light introduced into the polarization inversion element. For example, the length of the element is preferably about 30 mm or less, about 25 mm or less, or about 20 mm or less. The thickness of the single crystal is, for example, preferably about 10 mm or less, about 5 mm or less, or about 1 mm or less. However, any suitable lengths can be used.

For example, when the length of an element is approximately 20 mm and five periodic regions are included, the length of one periodic region will be about 4 mm. In addition, when the respective periods Δ are 3.25 μm, 3.28 μm, 3.31 μm, 3.34 μm, and 3.37 μm, about 600 pairs (each pair formed of layers with different polarization directions) of periods Δ will be formed.

It is preferable that a cooling/heating element such as a Peltier element is provided to contact the polarization inversion element. Temperature control prevents deterioration of the polarization inversion element due to the incoming laser light, and high output light can be obtained more stably.

In addition, in order to introduce light from the semiconductor laser to the polarization inversion element efficiently, a light-condensing member (such as a lens) may be placed between the semiconductor laser and the polarization inversion element, at the incident side of the polarization inversion element. For example, a lens provided with antireflection processing on either one side or both sides is preferable. When reflection at the light-condensing member is controlled (for example, reflection of 10% or less), single longitudinal mode oscillation can be avoided in the semiconductor laser so that the conversion efficiency can be further improved.

In the polarization inversion element of the invention, at the side closest to the incident side of the fundamental wave (that is the semiconductor laser side), conversion to the higher harmonic wave generally occurs efficiently. On the other hand, as the wavelengths are converted closer to the incident side of the fundamental wave, the longer become the distances from the points in the polarization inversion element where it is converted to emission point, so that the light is easier to attenuate. Also, as the wavelengths are converted closer to the emission side of the higher harmonic wave, the longer are the distances from the incident side of the fundamental wave in the polarization inversion element to the points where it is converted, so that the light is easier to attenuate. Therefore, in the laser device of the invention, in order to enhance the intensity of specific wavelength, for example, in view of the conversion efficiency and the attenuation within the polarization inversion element, a periodic region corresponding to the most desired converted wavelength (for example, the main wavelength) can be placed closer to the incident side of the fundamental wave than to the center. In addition, as described above, a periodic region corresponding to the most desired converted wavelength (for example, the main wavelength) can be assigned to a longer area. In addition, in view of the all the considerations described above, the periodic region corresponding to the most desired wavelength to convert into (for example, the main wavelength) can be assigned to a longer area and placed closer to the incident side of the fundamental wave. Such a configuration may be employed to enhance wavelengths other than the peak wavelength.

However, when only a part of a wavelength is enhanced, the intensity distribution of the obtained higher harmonic wave may differ from that of the fundamental wave. For example, when only the peak wavelength is enhanced, the intensity distribution of the obtained higher harmonic wave approaches the single longitudinal mode compared with the intensity distribution of the fundamental wave.

A laser device of the invention will be described more specifically by way of preferred embodiments with reference to the accompanying drawings.

### EXAMPLE 1

A semiconductor laser is prepared that is a BH-type laser comprising, for example, the layers of InₓGa_{1-x-y}As_{y}P_{1-y} as the n-layer, InₓGa_{1-x-y}As_{y}P_{1-y} (x=0.47, y=0.4) as the active layer, and InₓGa_{1-x-y}As_{y}P_{1-y} as the p-layer provided on a InP substrate, and a PNP thyristor structure provided to a side of the active layer, and grown by way of buried growth. In this laser, the oscillator length L is 500 um, λg is 1100 nm, and the interval of longitudinal modes is about 0.36 nm. Also, in the semiconductor laser, a trench structure is employed in order to improve the modulating speed (in other words, to reduce the parasitic capacitance).

With this arrangement, the cut-off frequency of f_{3dB} can be set 1 GHz or greater and the speed of digital modulation (200 MHz) can be converted to emit efficiently. The gain width (that is FWHM in this example) of the semiconductor laser is about 25 nm.

For the polarization inversion element, a Z-cut LiNbO₃:Mg with about 0.5 mm thickness and about 5 mol % concentration of added Mg is used as a substrate. For the period Δ, five periodic regions corresponding to periods Δ₁ to Δ₅, from 3.25 μm to 3.37 μm with the difference of the periods Δ between the adjacent periodic regions of 0.03 μm, are respectively formed in order to phase match at room temperature with the gain width of the fundamental wave having a fundamental wavelength of 1100 nm in multi-longitudinal-mode. An electrode for polarization inversion is formed on the +Z plane of the substrate to match the periods Δ₁ to Δ₅, and a high-voltage power supply is connected to apply positive electrical potential to the +Z plane and negative electrical potential to the −Z plane. A voltage exceeding the resistivity of the crystal against the electric field is applied. With this arrangement, as shown in FIG. 3, the polarization inversion element 23 having the polarization inversion periodic regions 24 to 28 with respective aiming periods Δ₁ to Δ₅ of 3.37 μm, 3.34 μm, 3.31 μm, 3.28 μm, and 3.25 μm are formed. The polarization inversion element was set to a 20 mm entire length and 5 mm width. In the periodic structure of the obtained polarization inversion, the ratio of polarization inversion in each periodic region is in a range from about 49.7 to about 50.3% and about ten longitudinal modes (Δλ is about 3.6 nm) can be simultaneously converted at once in a periodic region.

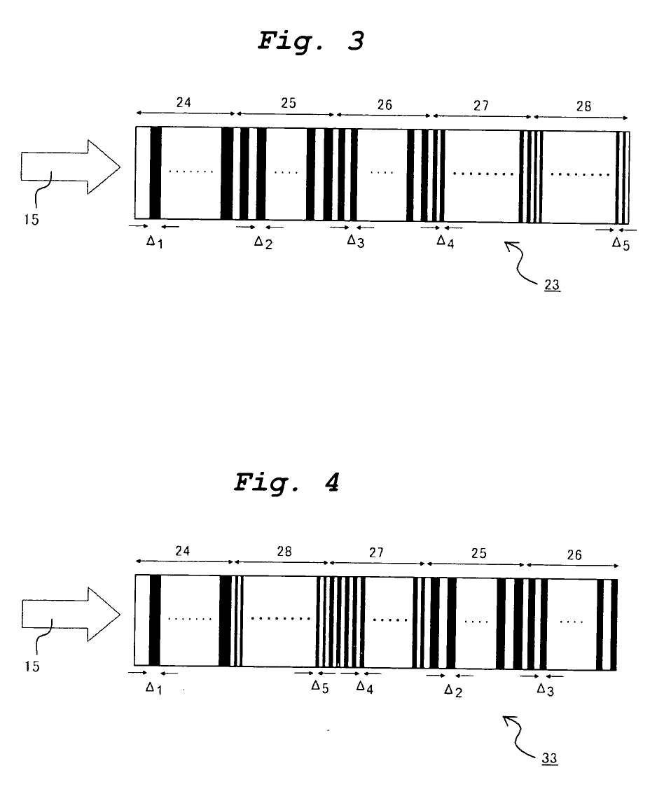

In a similar manner, as shown in FIG. 4, the polarization inversion element 33 is formed with the randomly placed polarization inversion periodic regions 24 to 28 having the respective periods Δ₁ to Δ₅.

In the polarization inversion element, an AR-coating, i.e, anti-reflectance coating, (reflectance R<1%) for light from 1000 nm to 1200 nm is applied for the reflectance characteristics of the incident side, and a coating with a reflectance R>80% is applied for the reflectance characteristics of the emission side. For the emission side, a dielectric coating is applied to make the reflectance R≦5% in order to obtain a dichroic mirror characteristic for 550 nm light.

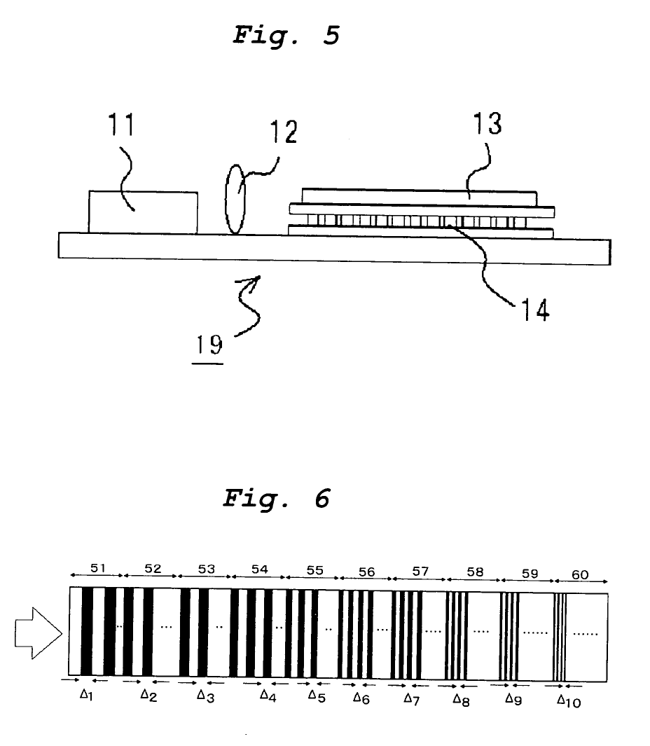

A laser device is fabricated by using the polarization inversion elements 23 and 33 having the polarization inversion structures as shown in FIG. 3 and FIG. 4 respectively. For the laser device, the configuration shown in FIG. 5 may be employed.

In the laser device 19 shown in FIG. 5, a lens 12 is placed between a semiconductor laser 11 and a polarization inversion element 13. An antireflection coating is applied to both sides of the lens 12 to adjust reflectivity to less than 1%.

Also, a Peltier element 14, used as the cooling element, is placed in contact with the polarization inversion element 13.

In the obtained laser device, when the fundamental wave of about 1100 nm is made incident at an output power of 500 mW from the semiconductor laser that is the light source, a green laser light (550 nm in wavelength) can be obtained at an output power of 150 mW with a conversion efficiency from the fundamental wave at about 30%.

### EXAMPLE 2

A semiconductor laser similar to that in Example 1 is used.

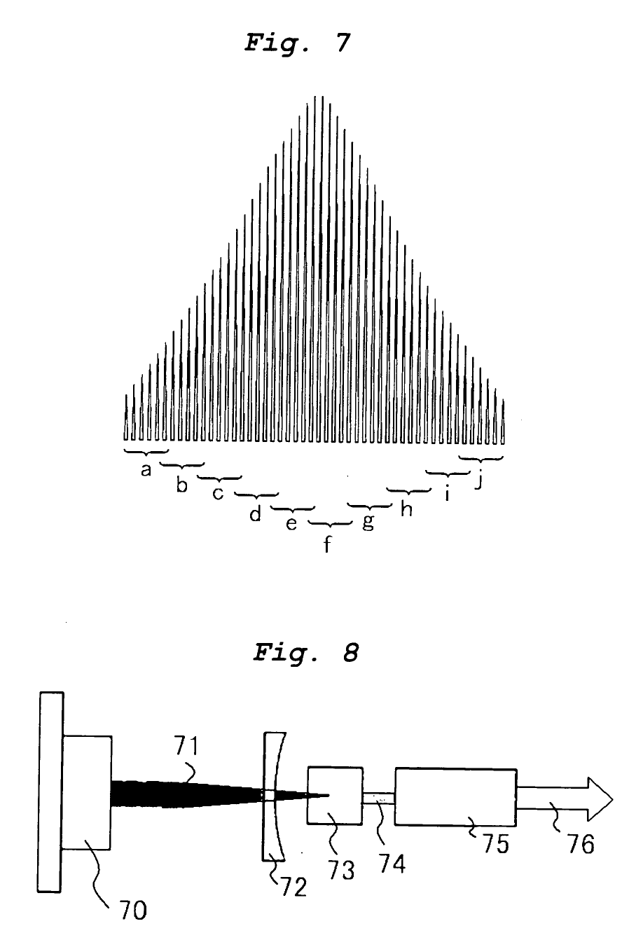

For the polarization inversion element, a similar substrate as in Example 1 is used, and in order to obtain phase matching with the multi-longitudinal mode fundamental wave of the fundamental wavelength of 1100 nm (interval of the longitudinal modes: about 0.36 nm, gain width: 25 nm) at room temperature, ten periodic regions 51 to 60 are formed, with aiming the periods Δ from 3.25 μm to 3.37 μm respectively at the difference of the periods Δ between the adjacent periodic regions of about 0.013 μm. That is, as shown in FIG. 6, a polarization inversion element has polarization inversion periodic regions 51 to 60 with respective aiming periods Δ₁ to Δ₁₀ of 3.250 μm, 3.263 μm, 3.277 μm, 3.290 μm, 3.303 μm, 3.317 μm, 3.330 μm, 3.343 μm, 3.357 μm, and 3.370 μm.

The polarization inversion element was set to 20 mm in entire length and 5 mm in width. The periodic structure of the obtained polarization inversion is similar to that in Example 1, in which the ratios of polarization inversion of the periodic regions are in a range from about 49.7% to about 50.3%. In the polarization inversion element, similar to that in Example 1, an AR coating (reflectance R<1%) for the incident side and a dielectric coating (reflectance R≦5%) for the emission side are applied respectively.

With such a polarization inversion element, a laser deice similar to that shown in FIG. 5 is fabricated.

In the obtained laser device, when the fundamental wave of about 1100 nm is made incident at an output power of 500 mW from the semiconductor laser light source, a green laser light (550 nm in wavelength) can be obtained at an output power of 150 mW with a conversion efficiency from the fundamental wave at about 30%. In addition, in the laser device, the wavelengths which can be converted in each periodic region in the polarization inversion element are, as shown in FIG. 7, set to overlap, for example, with approximately 1.2 nm each other between a and b, b and c, c and d, . . . , and i and j, and thus, a higher harmonic wave whose intensity distribution is corresponding to that of the fundamental wave can be obtained.

The invention has a wide range of industrial applications. The invention can be used in various fields where a laser light of approximately green color can be employed, and especially, suitably utilized in various displays and projectors.

It is to be understood that the foregoing descriptions and specific embodiments shown herein are merely illustrative of the best mode of the invention and the principles thereof, and that modifications and additions may be easily made by those skilled in the art without departing for the spirit and scope of the invention, which is therefore understood to be limited only by the scope of the appended claims.

What is claimed is:

1. A laser device comprising:
a light source comprising a semiconductor laser emitting a fundamental wave in a multi-longitudinal mode; and
a wavelength converting element comprising a polarization inversion element having at least two polarization inversion periodic regions, each region having a period Δ with respect to a longitudinal mode constructing the fundamental wave;
wherein a higher harmonic wave generated by the polarization inversion element is in a multi-longitudinal mode.

2. The laser device according to claim 1, wherein the polarization inversion element includes differences between the periods Δ of the periodic regions being set constant

3. The laser device according to claim 2, wherein the polarization inversion element includes respective differences between the periods Δ of the periodic regions being set to from 0.01 to 0.8 μm.

4. The laser device according to claim 3, wherein the polarization inversion element has the period Δ in a range between about 3.1 and about 3.5 μm.

5. The laser device according to claim 4, wherein the semiconductor laser emits a fundamental wave of in a multi-longitudinal mode having a main emission wavelength between about 1000 nm and about 1200 nm.

6. The laser device according to claim 5, wherein the semiconductor laser has an active layer represented by a formula InₓGa_{1-x-y}N_{z}As_{y}P_{1-y}, where 0.1<x<0.84, 0.25<y<0.5, and z=0 or 1.

7. The laser device according to claim 6, wherein the semiconductor laser, as a fundamental wave-emitting device, comprises a substrate made of InP.

8. The laser device according to claim 7, wherein the polarization inversion element is made of a single crystal of lithium niobate (LiNbO₃), lithium tantalate (LiTaO₃), lithium niobate-lithium tantalate solid solution, potassium titanyl phosphate (KTiOPO₄) or potassium lithium niobate (K₃Li₂Nb₅O₁₅).

9. The laser device according to claim 8, further comprising a cooling/heating element which is in contact with the polarization inversion element.

10. A laser device comprising:
a light source comprising a semiconductor laser emitting a fundamental wave in a multi-longitudinal mode; and
a wavelength converting element comprising a polarization inversion element having at least two polarization inversion periodic regions, each region having a period Δ with respect to a longitudinal mode constructing the fundamental wave;
wherein at least one periodic region is adjusted to match a plurality of longitudinal modes of the fundamental wave, and a higher harmonic wave generated by the polarization inversion element is in a multi-longitudinal mode.

11. The laser device according to claim 10, wherein the periodic region corresponding to the plurality of longitudinal modes is periodically chirped.

12. The laser device according to claim 11, wherein the polarization inversion element has a periodic region corresponding to the plurality of longitudinal modes, and a periodic region corresponding to at least one of the plurality of longitudinal modes and having a mean period different than a mean period of the periodic region corresponding to the plurality of longitudinal modes.

13. The laser device according to claim 12, wherein in the polarization inversion element, differences of the mean periods between the periodic regions is set minimum between most adjacent periodic regions.

14. The laser device according to claim 13, wherein in the polarization inversion element, differences of the mean periods between the periodic regions are set constant.

15. The laser device according to claim 13, wherein respective higher harmonic waves converted in periodic regions corresponding to the plurality of longitudinal modes and having different mean periods overlap each other.

16. A laser device comprising:
a light source comprising a semiconductor laser emitting a fundamental wave in a multi-longitudinal mode; and
a wavelength converting element comprising a polarization inversion element having at least two polarization inversion periodic regions, each region having a period Δ with respect to a longitudinal mode constructing the fundamental wave;
wherein at least one longitudinal mode of the fundamental wave as a common longitudinal mode, a wavelength of the common longitudinal mode can be converted in a plurality of periodic regions having different mean periods, and a higher harmonic wave generated by the polarization inversion element is in a multi-longitudinal mode.

17. The laser device according to claim 16, wherein the higher harmonic wave also corresponds to a longitudinal mode different than the common longitudinal mode in the plurality of periodic regions having different mean periods each other.

18. The laser device according to claim 17, wherein the polarization inversion element includes differences between the mean periods of the periodic regions being set to from 0.01 to 0.08 μm.

19. The laser device according to claim 18, wherein the polarization inversion element includes differences between the mean periods being set constant.

20. A method for manufacturing a laser device, comprising:
providing a light source that emits a fundamental wave in a multi-longitudinal mode; and
providing a wavelength converting element to convert light from the light source, and the wavelength converting element is a polarization inversion element having at least two polarization inversion periodic regions, each region having a period Δ with respect to a longitudinal mode constructing the fundamental wave, and the polarization inversion element generates a higher harmonic wave in a multi-longitudinal mode.
